(19) United States
(12) Patent Application Publication
(10) Pub. No.: US 2004/0003974 A1
(43) Pub. Date: Jan. 8, 2004

(54) Energy absoring bumper structure

(76) Inventor: Michael Ashmead, Huntingdon (GB)

Correspondence Address: SHERIDAN ROSS PC, 1560 BROADWAY, SUITE 1200, DENVER, CO, 80202

(21) Appl. No.: 10/381,277

(22) PCT Filed: Oct. 23, 2001
(86) PCT No.: PCT/GB01/04690

(30) Foreign Application Priority Data
Oct. 24, 2000 (GB) 00259879

(51) Int. Cl. F16F 7/12

(52) U.S. Cl. 188/377

(57) ABSTRACT

An energy-absorbing structure (10) comprising a sacrificial member (12) and a skin (14) for covering one side (16) of the sacrifical member (12). The skin (14) has an array (18) of grooves (20) formed in the surface (22) closest to the sacrifical member (12). The grooves (20) provide lines of wakness which improve yieldability of the structure (10) when in collision with large objects (e.g pedestrians), but without adversely affecting damage resistance to small object, e.g. stone chippings.

### FIELD OF INVENTION

The present invention relates to an energy-absorbing structure for absorbing impact energy.

### BACKGROUND ART

Energy-absorbing structures are widely used in vehicles such a motor cars to absorb energy should the vehicle be involved in an accident. By absorbing energy, less of the impact force generated in the accident is transmitted to the vehicle's occupants, thereby helping to avoid serious injury. Due to the success of such occupant-friendly energy absorbing structures, attention is now turning to energy-absorbing structures which could help reduce risk of serious injury to pedestrians involved in road accidents with vehicles.

Pedestrian-friendly energy-absorbing structures need to be located on the external periphery of vehicles; a location where aesthetics and certain other practical considerations are dominant factors in vehicle design. Thus, it must be possible to make such pedestrian-friendly structures smooth-skinned and with curving profiles. In addition, the structures must have an ability to withstand routine “wear and tear”, and an ability to yield sacrificially when impact energy exceeds a threshold level. However, these requirements present a problem in that making a structure which is able to withstand light impact (e.g. from stone chipping projectiles or even car wash brushes) suggests design criteria which are the antithesis of those required to make a structure with desired “yieldability” to safeguard pedestrians.

The present applicants have devised a novel, pedestrian-friendly energy-absorbing structure.

### DISCLOSURE OF INVENTION

In accordance with a first aspect of the present invention, there is provided an energy-absorbing structure for use with a vehicle as pedestrian crash padding, comprising a sacrificial member configured to deform permanently when absorbing impact energy; and a skin covering one side of the sacrificial member; characterised in that the skin has points or lines of weakness pre-formed therein.

It is believed that the points or lines of weakness in the skin will ease manufacture of components with complex, perhaps curving profiles, whilst at the same time ensuring there is sufficient skin strength to resist puncture by certain projectiles such as stone chippings which are commonly encountered on the roads. In addition, it is believed that the structure itself will have the requisite macroscopic yieldability to function as crash padding for pedestrians to help protect the pedestrians from serious injury.

Lines of weakness in the skin may be provided by an array of grooves or slots in one side of the skin. The said one side may be adjacent to the sacrificial member.

The skin may comprise a laminated structure with the array of grooves or slots being formed in a first layer of the laminated structure. A second or protective layer may be bonded to the first layer, the protective layer preventing gaps opening in the skin as the first layer deforms on impact. The protective layer may be more ductile that the first layer. The laminated structure may be in the form of a sandwich structure with the first layer being sandwiched between two protective layers, at least one of which prevents gaps opening in the skin as the first layer deforms on impact. The first layer may be bonded to the or each protective layer by an adhesive layer which is preferably of low modulus, for example polyurethane or epoxy adhesive. The adhesive layer may prevent delamination (i.e. the layers becoming detached from each other) by allowing slippage between the layers on impact.

The grooves or slots in the array may each have an elongate profile. The elongate profiles may be aligned. Some of the elongate profiles may be aligned in a first direction, and others may be aligned in a second direction. First and second directions may be substantially orthogonal to each other. The grooves or slots may form a grid-like or criss-cross pattern.

In one embodiment, the lines of weakness in the skin may be provided by a reinforcing sheet providing a first amount of reinforcement in one region and a second amount of reinforcement in another region, the first reinforcement being greater than the second. The skin may comprise a composite structure having a reinforcing sheet in the form of a textile fabric material, perhaps embedded in a matrix of resin. The textile fabric may have different weave densities to achieve the first and second amounts of reinforcement. Alternatively a mixture of higher and lower strength fibres woven may be employed.

The lower strength reinforcement fibres are weaker than the higher strength reinforcement fibres, the mixture may thus be arranged to form lines of weakness. The lines of weakness may form a grid-like pattern. The reinforcement fibres may be glass fibres of differing thickness with the higher strength fibres having greater thickness than the lower strength fibres.

The sacrificial member may comprise a honeycomb structure, possibly a honeycomb structure as described in International application WO98/06553, the entire contents of which are incorporated herein by reference. Alternatively, or additionally, the sacrificial member may comprise a press load (or egg box) structure, possibly as described in International application WO00/31434, the entire contents of which are incorporated herein by reference.

There is also provided a vehicle (preferably a motor vehicle such as a car) in which at least one external part comprises an energy-absorbing structure in accordance with the present invention.

In accordance with another aspect of the present invention, there is provided an energy transfer surface for an energy absorbing structure comprising a sheet of formable material having points or lines of weakness pre-formed therein. The sheet material may have some or all of the features of the skin used in the energy absorbing structure described above.

In accordance with another aspect of the present invention, there is provided a method of fabricating an energy-absorbing structure, comprising: providing a sacrificial member configured to deform permanently when absorbing impact energy; providing a skin to cover one side of the sacrificial member, the skin having points or lines of weakness therein; and bonding the skin to the sacrificial member to cover one side thereof.

The skin may be in the form of a laminated structure comprising a first layer having points or lines of weakness therein and a protective layer bonded to the first layer to prevent gaps opening in the skin as the first lacer deforms on impact. The points or lines of weakness may be provided by cutting an array of grooves or slots in the skin. The array may be cut in the surface of the skin which is bonded to the sacrificial member.

Alternatively, the lines of weakness in the skin may be provided by a reinforcing sheet providing a first amount of reinforcement in one region and a second amount of reinforcement in another region, the first reinforcement being greater than the second. The first and second amounts of reinforcement may be achieved by weaving a textile fabric material having regions of different weave densities. Alternatively, the first and second amounts of reinforcement may be achieved by employing a mixture of higher and lower strength fibres. The lower strength reinforcement fibres are weaker than the higher strength reinforcement fibres, and thus the mixture may be arranged to form lines of weakness.

The said one side of the sacrificial member may have a profile, and the skin may be pre-formed into a shape which corresponds to the profile of the said one side before it is covered.

### BRIEF DESCRIPTION OF DRAWINGS

An embodiment of the invention will now be described by way of example, with reference to and as illustrated in the accompanying drawings in which:

FIG. 1 is an exploded cross-sectional view of an energy-absorbing structure embodying the present invention;

FIG. 2 is a schematic cross-sectional view of the energy-absorbing structure of FIG. 1, shown in context with a vehicle;

FIG. 3 is a flow chart illustrating one method of fabricating the energy-absorbing structure of FIG. 1;

FIG. 4a is a plan view of one embodiment of a skin for the energy absorbing structure of FIG. 1;

FIG. 4b is a cross-section along line AA of FIG. 4a;

FIG. 5a is a plan view of another embodiment of a skin for the energy absorbing structure of FIG. 1;

FIG. 5b is a cross-section along line AA of FIG. 5a;

FIG. 6a is a schematic plan view of yet another embodiment of a skin for the energy absorbing structure of FIG. 1;

FIG. 6b is a cross-section along line AA of FIG. 6a;

FIG. 7a is a schematic plan view of yet another embodiment of a skin for the energy absorbing structure of FIG. 1;

FIG. 7b is a cross-section along line AA of FIG. 7a;

FIG. 8a is a plan view of still another embodiment of a skin for the energy absorbing structure of FIG. 1;

FIG. 8b is a cross-section along line AA of FIG. 8a; and

FIG. 9 is a perspective view of another embodiment of a sacrificial member for the energy-absorbing structure of FIG. 1;

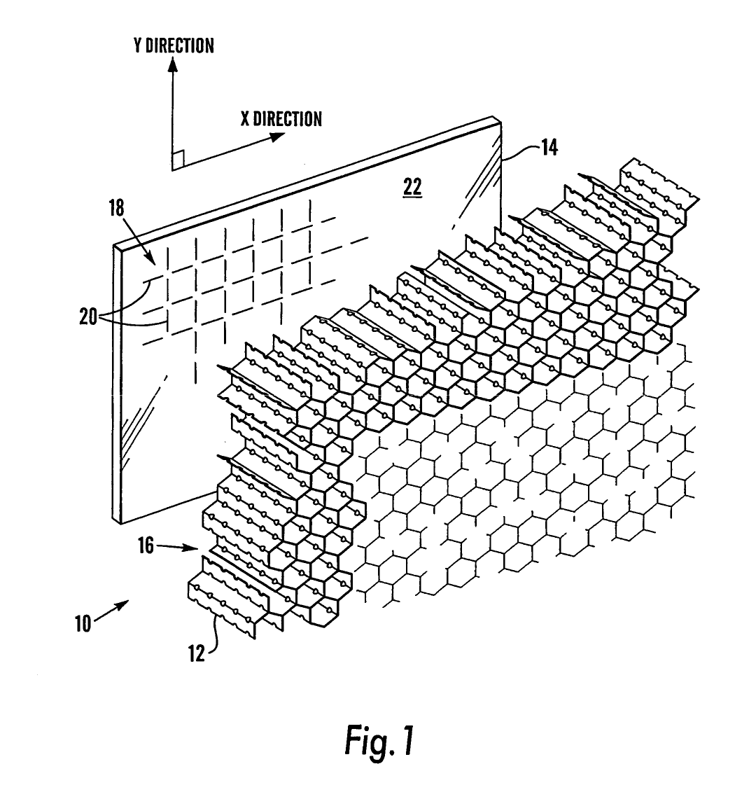

FIG. 1 shows an exploded perspective view of an energy-absorbing structure 10 comprising a sacrificial member 12 (shown partly in phantom lines) and a skin 14 for covering one side 16 of the sacrificial member 12. The sacrificial member 12 is configured to deform permanently hen absorbing impact energy and is illustrated as a honeycomb structure, but could easily be of “egg box” or other design). The skin 14 comprising metal (e.g. aluminium) has an array 18 of grooves 20 formed in the surface 22 closest to the sacrificial member 12. Some of the grooves 20 are aligned in a first direction (X-direction) and others are aligned in a second direction (Y-direction) which is orthogonal to the first direction. Ends of grooves 20 in the first and second directions are adjacent to form a grid-like pattern in the surface. The grooves 20 provide lines of weakness which improve yieldability of the structure 10 when in collision with large objects (e.g. pedestrians), but without adversely affecting damage resistance to small object, e.g. stone chippings.

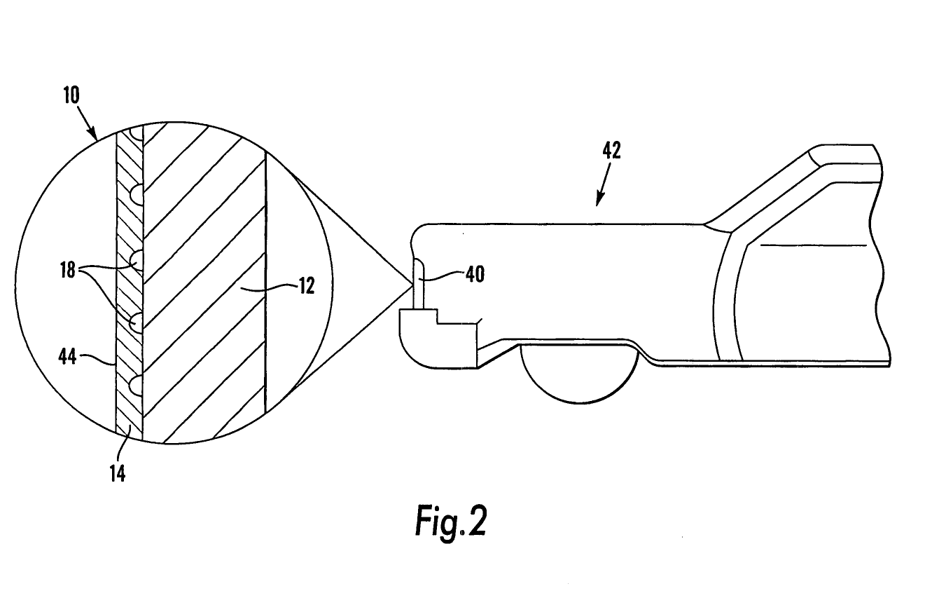

FIG. 2 shows an enlarged cross-section view of the energy-absorbing structure 10 forming a front part 40 of a motor vehicle 42. The outermost surface 44 of the skin 14 is smooth and may be highly polished or painted in the same way as conventional body panels of motor vehicles.

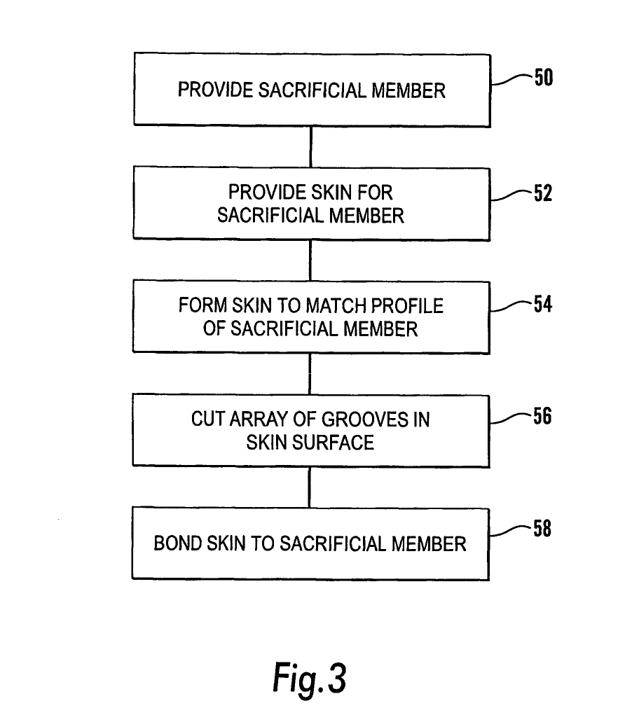

FIG. 3 is a flow chart illustrating one method of forming the energy-absorbing structure 10. A sacrificial member is provided at 50 and has a desired profile corresponding to the intended use of the structure 10, e.g. curved profile of a car bumper. A skin of complementary size is provided at 52 and then formed (with heat) at 54 to match the profile of the sacrificial member so as to be a snug fit around one side of it. Once formed, the skin is mounted on a jig and an array of grooves is cut at 56 into one surface of the skin. (The array of grooves could be formed by electrochemical machining or even spark erosion). The skin is then bonded at 58 to the sacrificial member, with the grooves adjacent the sacrificial member.

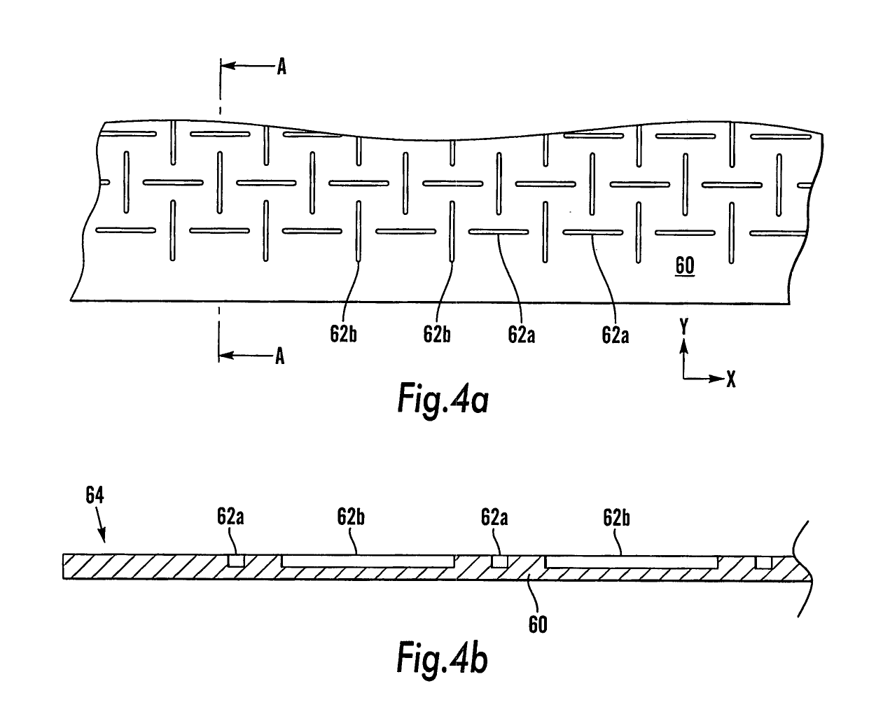

FIGS. 4a to 8b show skins having lines of weakness which may be used to cover one side of the sacrificial member for example the member 16 shown in FIG. 1. Alternatively, the skins may be used alone as an energy transfer surface.

In FIGS. 4a and 4b, the skin 60 comprises a single layer of metal, e.g. aluminium. The lines of weakness are formed by elongate grooves 62a,b having a length of approximately 20 mm to 30 mm, a width of approximately 1 mm and a depth approximately half the thickness of the skin. Each end of the groovees 62a,b are curved and have a substantially semi-circular shape. The grooves are formed in the surface 64 which is mounted closest to the sacrificial member (not shown).

Approximately half of the grooves 62a are aligned in a first direction (X-direction) and the remainder (grooves 62b) are aligned in a second direction (Y-direction) which is orthogonal to the first direction. The grooves 62a,b are arranged with one groove in one direction bisecting the space between a pair of grooves in the other direction. The grooves 62a,b thus form a criss-cross pattern in the surface.

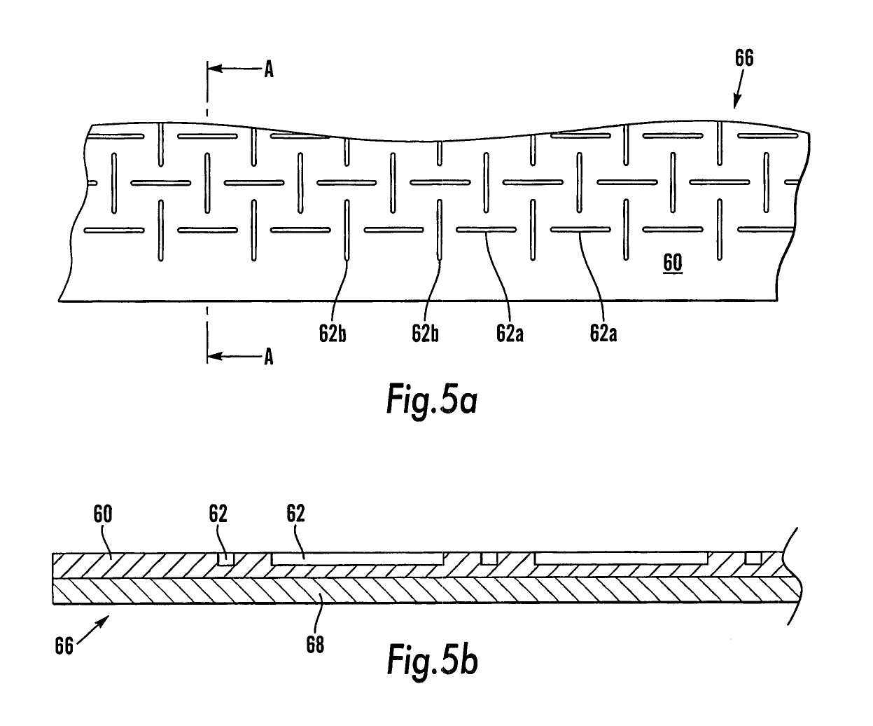

Any tendency for gaps to open in the skin 60 may be alleviated or prevented by mounting the skin 60 on an outer protective layer 68 of high stretch material, e.g. plastics or resilient paint, to form the skin 66 of FIGS. 5a and 5b. The skin 66 is thus a laminated structure with the outer layer 68 forming an impact surface.

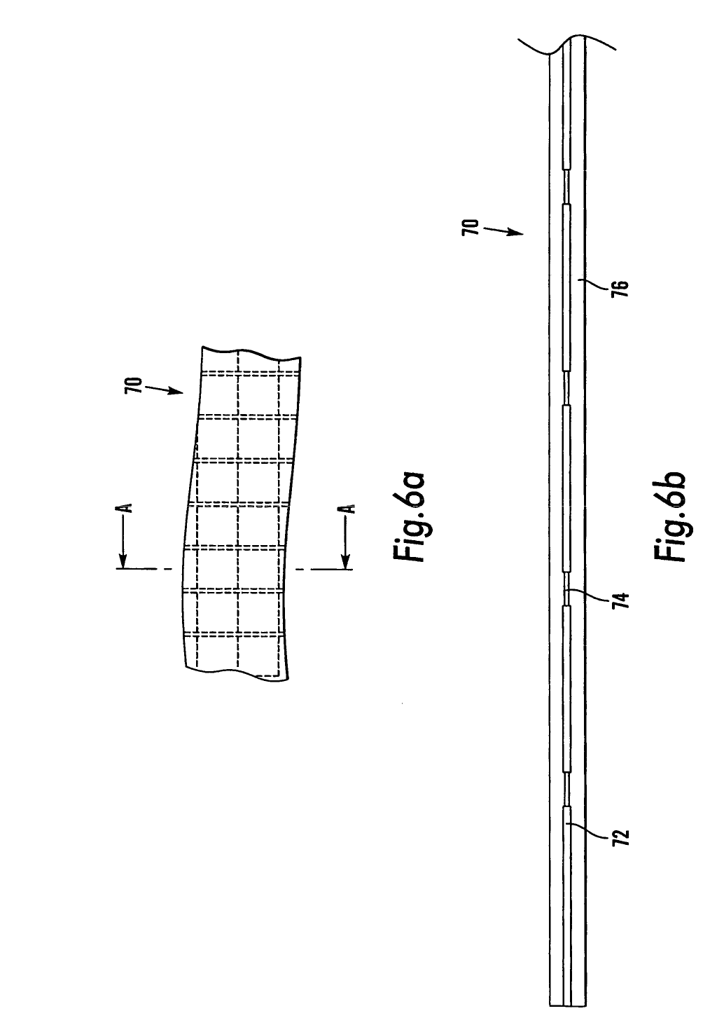

In FIGS. 6a and 6b, the skin 70 is a composite structure comprising higher strength and lower strength reinforcement fibres 72,74 e.g. glass, mounted in a resin matrix 76. The lower strength reinforcement fibres 74 are thinner and hence weaker than the higher strength reinforcement fibres 72. The lower strength reinforcement fibres 74 may also have a lower density than the higher strength reinforcement fibres 72. The lower strength reinforcement fibres 74 form a grid-like pattern of lines of weakness shown as dashed lines in FIG. 6a.

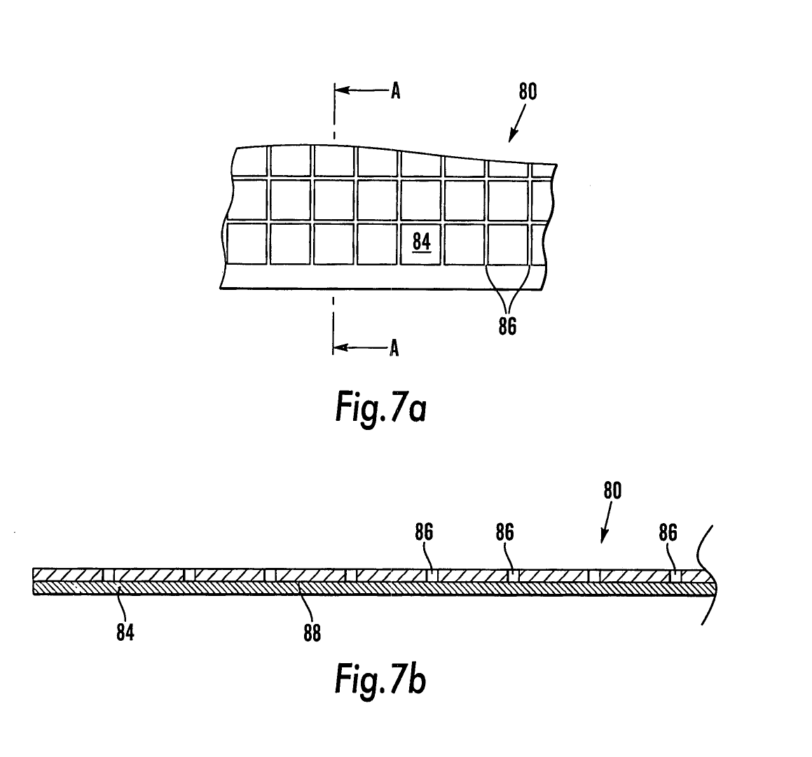

In FIGS. 7a and 7b, the skin 80 is a laminate formed from first and second layers 82, 84. The first layer 82 may be mounted adjacent the energy absorber (not shown) and is formed from metal, e.g. aluminium. The second or outer protective layer 84 is a thin gauge skin of metal, e.g. aluminium. The two layers 82,84 are bonded using a layer of low modulus adhesive 88, e.g. polyurethane or epoxy adhesives. The adhesive layer 88 allows for slippage between the first and second layers 82,84 to prevent delamination on impact.

The lines of weakness are formed in the first layer 82 by eroding slots 86 forming apertures therethrough, e.g. by electrochemical machining or spark erosion. The slots may be eroded after the layers have been bonded and in this way the layer of adhesive prevents 88 erosion into the second layer 84. The slots 86 extend across the length and width of the first layer in two perpendicular directions to form a grid-like pattern. The slots 86 have a width of approximately 1 mm and extend through the first layer 82. As with the embodiment of FIGS. 5a and 5b, the second layer 84 prevents gaps opening in the skin as the first layer 82 deforms on impact.

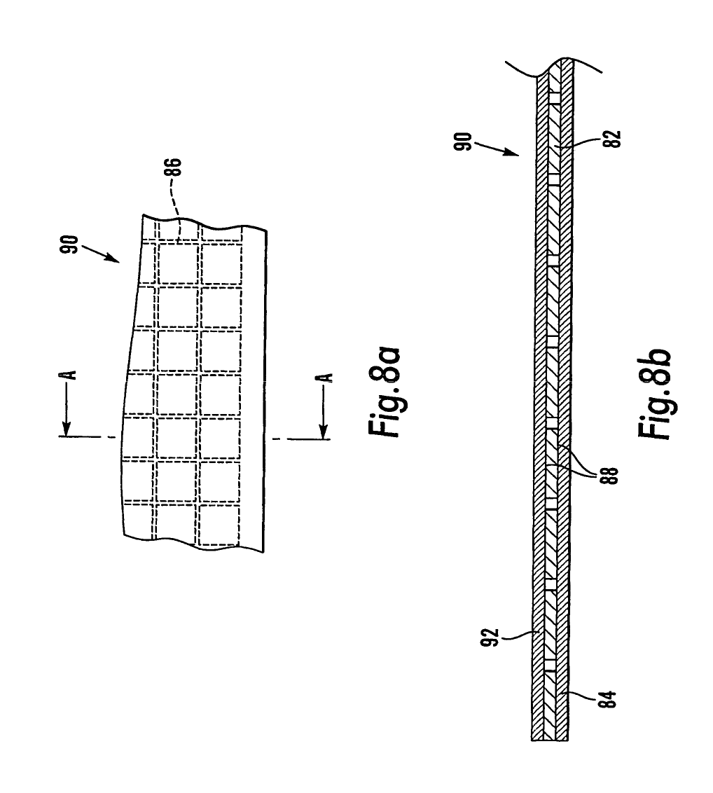

In FIGS. 8a and 8b, the skin 90 is a laminate formed from the skin 80 of FIGS. 7a and 7b mounted to a additional protective layer 92 by a layer of adhesive 88. The additional or third layer 92 is a thin gauge skin of metal, e.g. aluminium. The laminate thus comprises a slotted layer 82 consisting of square or rectangular “islands” sandwiched between two thin gauge skins or layers 92,84. The slots 86 are shown in dashed lines in FIG. 8a and may fill with adhesive when bonding to the additional layer. The additional layer 82 may be mounted adjacent an energy absorber.

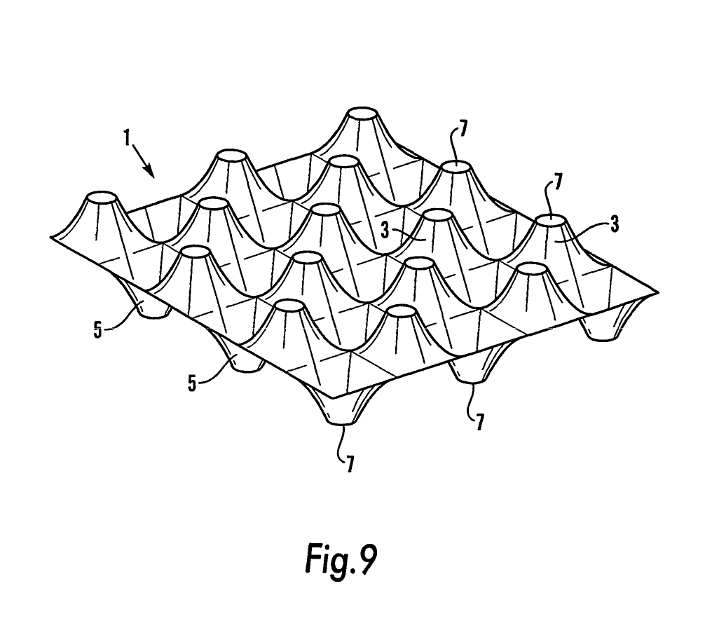

FIG. 9 shows an alternative sacrificial member in the form of a non-planar member 1 having a pattern of alternating front projections 3 and rear projections 5, without substantial flat areas therebetween. The projections are frustoconical and hollow with substantially flat tops 7.

Each projection has a height of 30 mm and a flat top 7 having a diameter of 10 mm. The interpitch, i.e. distance between two projections extending from the same face of the sheet, is 50 mm. Each projection has a pitch region, namely the portion of the member between the tops of the projections. The pitch region is inclined at an angle θ of approximately 26.5 degrees to a median plane which is a notional plane which locally represents the position of the non-planar member with the projections smoothed out. The flat tops are parallel to the median plane.

The parameters and pattern of the projections may be varied by selecting values from the following table:

| | Height | Diameter | Interpitch | Angle A |
|---|---|---|---|---|
| | H (mm) | D (mm) | P (mm) | (degrees) |
| Geometry 1 | 20 | 15 | 70 | 45 |
| Geometry 2 | 10 | 9 | 35 | 40 |
| Geometry 3 | 20 | 12.5 | 50 | 32 |
| Geometry 5 | 10 | 12.5 | 50 | 51.34 |
| Geometry 6 | 10 | 12.5 | 30 | 14 |
| Geometry 7 | 30 | 10 | 50 | 26.5 |
| Geometry 8 | 15 | 12.5 | 50 | 40 |
| Geometry 9 | 7.5 | 3.125 | 12.5 | 22.6 |
| Geometry 10 | 12.5 | 12.5 | 50 | 45 |
| Geometry 11 | 10 | 7.5 | 35 | 45 |
| Geometry 12 | 15 | 11.25 | 52.5 | 45 |
| Geometry 13 | 25 | 18.75 | 87.5 | 45 |
| Geometry 14 | 30 | 22.5 | 105 | 45 |

1. An energy-absorbing structure (10) for use with a vehicle, comprising a sacrificial member (12) configured to deform permanently when absorbing impact energy; and a skin (14) covering one side of the sacrificial member; characterised in that the skin has points or lines of weakness (20) pre-formed therein which are configured to improve macroscopic yieldability of energy absorbing structure when impact energy exceeds a threshold level, whereby the energy-absorbing structure provides pedestrian crash-padding when used externally on a vehicle.

2. An energy-absorbing structure according to claim 1, in which the skin comprises a laminated structure, with the points or lines of weakness being formed in a first layer of the laminated structure.

3. An energy-absorbing structure according to claim 2, in which the skin comprises another layer configured as a protective layer to prevent gaps opening in the skin when the first layer deforms on impact.

4. An energy-absorbing structure according to claim 2 or claim 3, in which the laminated structure is in the form of a sandwich structure with the first layer being sandwiched between two protective layers, at least one of which prevents gaps opening in the skin as the first layer deforms on impact.

5. An energy-absorbing structure according to any one of claims 2 to 4, in which the first layer is bonded to the or each protective layer by an adhesive layer which allows for slippage between layers during impact.

6. An energy-absorbing structure according to any one of claims 1 to 5, in which the lines of weakness in the skin are provided by an array of grooves or slots in one side of the skin.

7. An energy-absorbing structure according to claim 6, in which the said one side of the skin is adjacent to the sacrificial member.

8. An energy-absorbing structure according to claim 6 or claim 7, in which the grooves or slots in the array each have an elongate profile.

9. An energy-absorbing structure according to claim 8, in which at least some of the elongate profiles are aligned.

10. An energy-absorbing structure according to claim 9, in which some of the elongate profiles are aligned in a first direction, and others are aligned in a second direction.

11. An energy-absorbing structure according to claim 10, in which the first and second directions are substantially orthogonal to each other.

12. An energy-absorbing structure according to any one of claims 1 to 5, in which the lines of weakness in the skin are provided by a reinforcing sheet providing a first amount of reinforcement in one region and a second amount of reinforcement in another region, the first reinforcement being greater than the second.

13. An energy-absorbing structure according to claim 12, in which the skin comprises a composite structure having a reinforcing sheet in the form of a textile fabric material.

14. An energy-absorbing structure according to claim 13, in which the textile fabric has different weave densities to achieve the first and second amounts of reinforcement.

15. An energy-absorbing structure according to claim 13, in which the textile fabric has a mixture of higher and lower strength fibres.

16. An energy-absorbing structure according to any one of the preceding claims, in which the sacrificial member has a structure selected from the group consisting of a honeycomb structure and a press load structure.

17. A vehicle in which at least one external part comprises an energy-absorbing structure in accordance with any one of the preceding claims.

18. A method of fabricating pedestrian crash-padding for use externally on a vehicle, comprising: providing a sacrificial member configured to deform permanently when absorbing impact energy; providing a skin to cover one side of the sacrificial member, the skin having points or lines of weakness therein configured to improve macroscopic yieldability of the skin and the sacrificial member when impact energy exceeds a threshold level; and bonding the skin to the sacrificial member to cover one side thereof.

19. A method according to claim 18, comprising providing a skin in the form of a laminated structure comprising a first layer having points or lines of weakness therein and a protective layer bonded to the first layer to prevent gaps opening in the first layer on impact.

20. A method according to claim 18 or claim 19, comprising cutting an array of grooves or slots in the skin to provide the points or lines or weakness.

21. A method according to claim 20, comprising cutting the array is cut in the surface of the skin, then bonding the skin to the sacrificial member.

22. A method according to claim 18, comprising providing lines of weakness in the skin by providing a reinforcing sheet providing a first amount of reinforcement in one region and a second amount of reinforcement in another region, the first reinforcement being greater than the second.

23. A method according to claim 22, comprising weaving a textile fabric material having regions of different weave densities to provide the first and second amounts of reinforcement.

24. A method according to claim 22, comprising weaving a textile fabric material having a mixture of higher and lower strength fibres to provide the first and second amounts of reinforcement.
